(19) United States
(12) Patent Application Publication
(10) Pub. No.: US 2017/0347029 A1
(43) Pub. Date: Nov. 30, 2017

(54) MONITORING SYSTEM AND METHOD

(71) Applicant: Chiun Mai Communication Systems, Inc., New Taipei (TW)

(72) Inventor: CHAN-YU LIN, New Taipei (TW)

(21) Appl. No.: 15/605,969

(22) Filed: May 26, 2017

(30) Foreign Application Priority Data
May 28, 2016 (CN) 201610360483.5

(51) Int. Cl. H04N 5/232; H04N 7/18; G06K 7/10

(52) U.S. Cl. CPC H04N 5/23241; G06K 7/10425; H04N 7/181

(57) ABSTRACT

A monitoring system to monitor a monitoring region includes a number of identifying devices, a number of cameras corresponding to the identifying devices, at least one server, and a monitoring center. The monitoring region includes multiple monitoring sub-regions. The identifying devices are located in the monitoring sub-regions, and identifies a number of signal generating devices entering the monitoring sub-regions. Each camera is located in a corresponding monitoring sub-region, and obtains images of the corresponding monitoring sub-region. The server stores current positions and images of the signal generating devices. The monitoring center searches for a certain signal generating device. If the certain signal generating device is found by the identifying devices, the monitoring center activates the camera corresponding to the monitoring sub-region in which the certain signal generating device is located, and displays images of the certain signal generating device in real time.

### CROSS-REFERENCE TO RELATED DISCLOSURES

This disclosure claims priority to Chinese Patent Application No. 201610360483.5 filed on May 28, 2016, the contents of which are incorporated by reference herein.

### FIELD

The disclosure generally relates to monitoring systems and methods, and particularly to a monitoring system and method combining radio frequency identification (RFID) devices and cameras.

### BACKGROUND

A monitoring system commonly includes a plurality of cameras located in a monitoring region. A user can remotely monitor the monitoring region by a cloud system. However, the monitoring system with the cameras is commonly limited to a relatively area.

### BRIEF DESCRIPTION OF THE DRAWINGS

Many aspects of the present disclosure can be better understood with reference to the drawings. The components in the drawings are not necessarily drawn to scale, the emphasis instead being placed upon clearly illustrating the principles of the disclosure. Moreover, in the drawings, like reference numerals designate corresponding parts throughout the views.

FIG. 1 is a system architecture of an exemplary embodiment of a monitoring system.

FIG. 2 is a flowchart of an exemplary embodiment of a monitoring method corresponding to the monitoring system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiment described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

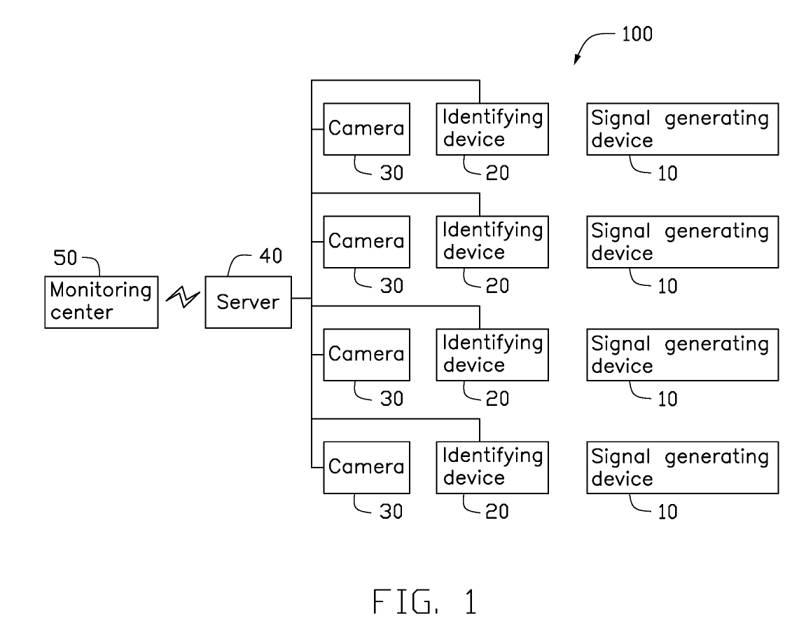

FIG. 1 shows a system architecture of an exemplary of a monitoring system. The monitoring system 100 includes a plurality of signal generating devices 10, a plurality of identifying devices 20, a plurality of cameras 30, a server 40, and a monitoring center 50. In one exemplary embodiment, the system architecture can be implemented in a monitoring region inside a building, e.g. a hospital, a nursing home, or the like and configured to monitor particular people, e.g. patients and visitors. The system architecture can also be implemented in the monitoring region outside a building, e.g. a parking lot, or the like and configured to monitor vehicles. The monitoring system 100 can also be configured to monitor other articles in the monitoring region.

The signal generating devices 10 are configured to identify the people, vehicles, and articles, etc. in the monitoring region. Each signal generating device 10 has an identification (ID) and can generate an identifying signal so that the identifying devices 20 can identify people, vehicles, and articles accordingly. The identifying signal can include the ID of the signal generating device 10 and information (e.g. a name, a telephone number, age of person, a type, a license number, and a color of a vehicle, or a name and a number of an article, etc.) of people, vehicles, and articles. In this exemplary embodiment, the signal generating devices 10 are RFID tags. The RFID tags can be attached to people, vehicles, and articles that need to be monitored. In other exemplary embodiment, the signal generating devices 10 can be any electronic devices that can generate the identifying signal, such as BLUETOOTH or WI-FI devices.

The identifying devices 20 are located in the monitoring region, and configured to detect and identify the signal generating devices 10. In this exemplary embodiment, the identifying devices 20 are RFID readers. The identifying device 20 can identify and read the identifying signal of the signal generating device 10. In this exemplary embodiment, the monitoring region includes multiple monitoring sub-regions. One identifying device 20 is located in each monitoring sub-region, and each identifying device 20 includes position information. Current position information of each signal generating device 10 is defined as the position information of the identifying device 20 which identifies the generating device 10. When one or more identifying device 20 identifies one or more generating device 10, the identifying device 20 detects and reads the identifying signal generated by the signal generating device 10.

In addition, when the generating device 10 is identified by multiple identifying devices 20, the current position information of the signal generating device 10 is defined as the position information of the identifying device 20 that receives the strongest signal intensity from the signal generating device 10.

The cameras 30 are located in the monitoring region. The cameras 30 correspond to the identifying devices 20. Each camera 30 is located in the monitoring sub-region where the corresponding identifying device 20 is located. Each camera 30 is configured to obtain images of the corresponding monitoring sub-region. In this exemplary embodiment, each camera 30 corresponds to one identifying device 20. In other exemplary embodiment, the relationship between a camera 30 and an identifying device 20 can be one-to-multiple, multiple-to-one, or multiple-to-multiple.

The server 40 is configured to store the identifying information, the current position, and image information of all of the signal generating devices 10.

The monitoring center 50 is configured to search for a certain signal generating device 10. In this exemplary embodiment, the monitoring center 50 can control the identifying devices 20 to search for the certain signal generating device 10. In this exemplary embodiment, the monitoring center 50 can include at least one display. If the certain signal generating device 10 is found by the identifying devices 20, the monitoring center 50 activates the camera 30 corresponding to the monitoring sub-region in which the certain signal generating device 10 is located, and displays the image of the certain signal generating device 10 in real time. If the certain signal generating device 10 is not found by the identifying devices 20, the monitoring center 50 obtains the last position information of the certain signal generating device from the server 40, and the monitoring center 50 activates the camera 30 corresponding to the sub-region corresponding to the last position information. Therefore, a user can find the certain signal generating device 10 according to the real-time image and the last position information.

In other exemplary embodiment, the monitoring center 50 and the server 40 can be merged together as a server.

In other exemplary embodiment, an initial state of the cameras 30 can be activated to monitor the signal generating devices 10 in the monitoring sub-region in real time. The server 40 stores the current image and position information of each signal generating device 10. If the signal generating device 10 is found by one or more identifying devices 20, the pre-powered camera 30 does not require to be activated by the control center 50, and the screen captured by the camera 30 can be immediately shown. If the signal generating device 10 is not found by the identifying devices 20, the control center 50 can display the last-captured image of the signal generating device 10 stored in the server 40.

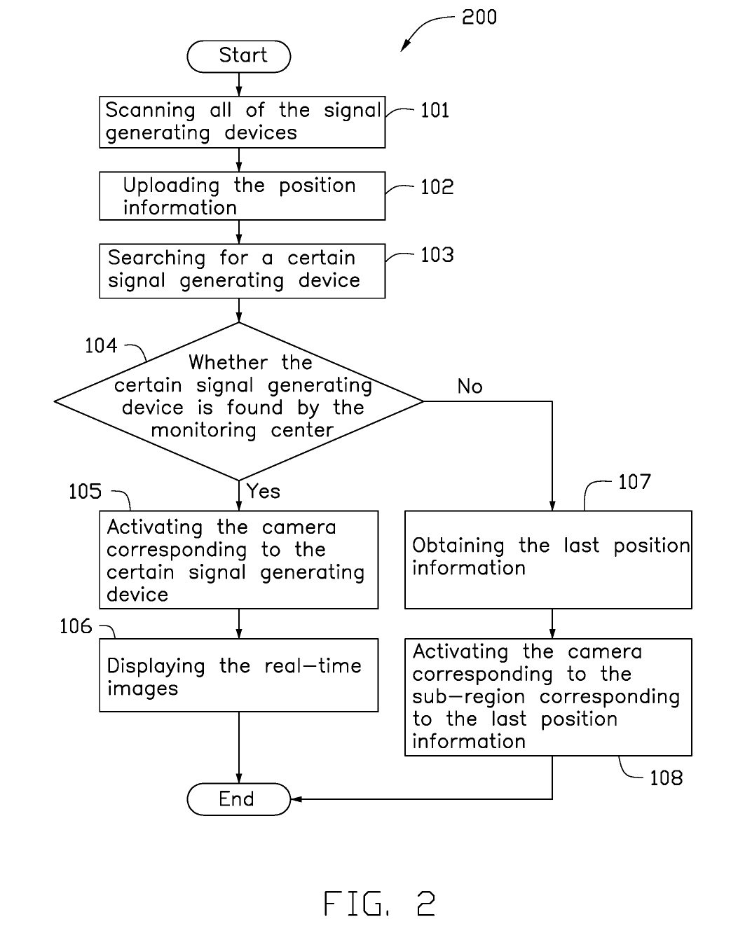

FIG. 2 illustrates a flowchart of an exemplary embodiment of monitoring method. In at least one exemplary embodiment, the method 200 is provided by way of example, as there are a variety of ways to carry out the method. The method 200 described below can be carried out using the allocations illustrated in FIG. 1, for example, and various elements of these figures are referenced in explaining exemplary method. Each block shown in FIG. 2 represents one or more processes, methods, or subroutines, carried out in the exemplary method. Furthermore, the illustrated order of blocks is by example only and the order of the blocks can change. The exemplary method 200 can begin at block 101. Depending on the exemplary embodiment, additional steps can be added, others removed, and the ordering of the steps can be changed.

At block 101, each identifying device 20 scans all of the signal generating devices 10, identifies and reads the identifying information of all of the signal generating devices 10 in the corresponding monitoring sub-region.

At block 102, each identifying device 20 uploads the current position information and the ID of all of the signal generating devices 10 to the server 40. The server 40 stores the current position information and the ID.

In other exemplary embodiment, block 101 and block 102 can be repeated at a preset time intervals, such as one second, ten seconds, and ten minutes so that the current position of each signal generating device 10 can be updated timely.

At block 103, the monitoring center 50 searches for a certain signal generating device 10. In this exemplary embodiment, the control center 50 controls the identifying devices 20 to search for the certain signal generating device 10 by the ID of the certain signal generating device 10.

At block 104, if the certain signal generating device 10 is found by one or more identifying devices 20, the process goes to block 105, and if the certain signal generating device 10 is not found by the identifying devices 20, the process goes to block 107.

At block 105, the monitoring center 50 activates the camera 30 corresponding to the monitoring sub-region in which the certain signal generating device 10 is located.

At block 106, the monitoring center 50 displays images of the certain signal generating device 10 in real time. Therefore, the monitoring center 50 can timely find the certain signal generating device 10 according to the real-time images.

At block 107, the monitoring center 50 obtains the last position information of the certain signal generating device 10 from the server 40.

At block 108, the monitoring center 50 activates the camera 30 corresponding to the sub-region corresponding to the last position information and displays an image of the last position of the certain signal generating device 10. Therefore, the monitoring center 50 can find the certain signal generating device 10 in time according to the image of the last position.

In other exemplary embodiment, at block 102, the cameras 30 corresponding to each identifying device 20 is activated to monitor the signal generating device 10 in real time, and stores the current image and position information to the server 40. Accordingly, at block 105, the monitoring center 50 does not need to activate the cameras 30 corresponding to the certain signal generating device 10 and directly switch to the image of the camera 30 corresponding to the signal generating device 10 as a monitoring screen, and at block 108, the monitoring center 50 can also display the last-captured image of the certain signal generating device 10 stored in the server 40.

The monitoring system 100 and method can monitor a relative larger scope by a manner of combing the identifying device 20 and the cameras 30. Regarding the certain signal generating device 10, no matter whether it can be found by the control center 50, the user can timely find the certain signal generating device 10 according to the real-time image and the last position information.

It is to be understood, however, that even through numerous characteristics and advantages of the present disclosure have been set forth in the foregoing description, together with details of assembly and function, the disclosure is illustrative only, and changes may be made in details, especially in the matters of shape, size, and arrangement of parts within the principles of the disclosure to the full extent indicated by the broad general meaning of the terms in which the appended claims are expressed.

What is claimed is:

1. A monitoring system to monitor a monitoring region, wherein the monitoring region comprises multiple monitoring sub-regions, the system comprising:
a plurality of identifying devices, located in the monitoring sub-regions, identifying a plurality of signal generating devices entering the monitoring sub-regions;
a plurality of cameras, corresponding to the identifying devices, each camera located in a corresponding monitoring sub-region, and each camera obtaining images of the corresponding monitoring sub-region;
at least one server storing current positions and images of the signal generating devices identified by the identifying devices; and
a monitoring center searching for a certain signal generating device by the identifying devices, wherein if the certain signal generating device is found by the identifying devices, the monitoring center activates the camera corresponding to the monitoring sub-region in which the certain signal generating device is located, and displays images of the certain signal generating device in real time.

2. The monitoring system of claim 1, wherein if the certain signal generating device is not found by the identifying devices, the monitoring center obtains last position information of the certain signal generating device from the server, the monitoring center activates the camera corresponding to the sub-region corresponding to the last position information.

3. The monitoring system of claim 1, wherein one identifying device is located in each monitoring sub-region, each identifying device comprises position information, current position information of each signal generating device is defined as the position information of the identifying device identifying the signal generating device.

4. The monitoring system of claim 2, wherein when the signal generating device is identified by multiple identifying devices, the current position information of the signal generating device is defined as the position information of the identifying device receiving a strongest signal intensity from the signal generating device.

5. The monitoring system of claim 1, wherein each signal generating device comprises an identification, the monitoring center controls the identifying devices to search for the certain signal generating device by the identification of the certain signal generating device.

6. A monitoring method to monitor a monitoring region, wherein the monitoring region comprises multiple monitoring sub-regions, the method comprising:
providing a plurality of identifying devices and a plurality of cameras; wherein the plurality of identifying devices are located in the monitoring sub-regions, and identifying a plurality of signal generating devices entering the monitoring sub-regions; wherein the plurality of cameras are corresponding to the plurality of identifying devices, each camera is located in a corresponding monitoring sub-region and obtaining images of the corresponding monitoring sub-region;
storing current positions and current images of the signal generating devices identified by the identifying devices;
searching for a certain signal generating device by the identifying devices;
if the certain signal generating device is found by the identifying devices, activating the camera corresponding to the monitoring sub-region in which the certain signal generating device is located, to display images of the certain signal generating device in real time.

7. The monitoring method of claim 6, further comprises:
if the certain signal generating device is not found by the identifying devices, obtaining last position information of the certain signal generating device from the server, and activating the camera corresponding to the sub-region corresponding to the last position information.

8. The monitoring method of claim 6, wherein one identifying device is located in each monitoring sub-region, each identifying device comprises position information, current position information of each signal generating device is defined as the position information of the identifying device identifying the signal generating device.

9. The monitoring method of claim 8, wherein when the signal generating device is identified by multiple identifying devices, the current position information of the signal generating device is defined as the position information of the identifying device receiving a strongest signal intensity from the signal generating device.

10. The monitoring method of claim 6, wherein each signal generating device comprises an identification, the monitoring center controls the identifying devices to search for the certain signal generating device by the identification of the certain signal generating device.
